(19) United States
(12) Patent Application Publication
(10) Pub. No.: US 2003/0203118 A1
(43) Pub. Date: Oct. 30, 2003

(54) Oscillating dispersion apparatus, system, and method

(76) Inventor: Roger D. Wickes, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/308,403

(22) Filed: Dec. 3, 2002

Related U.S. Application Data
(60) Provisional application No. 60/375,863, filed on Apr. 26, 2002.

(51) Int. Cl. B05D 1/02

(52) U.S. Cl. 427/425

(57) ABSTRACT

An apparatus, system, and method for oscillating the dispersion of a material is provided, which includes a first tube having a plurality of openings through which material passes. One of the openings of the first tube is coupled to a material source. A second tube is provided with an opening positioned at its end for receipt of a portion of the first tube, which assists in guiding the movement of the first tube. The second tube may also have one of more openings positioned along its length that help to form a material ejection stream. A target rotator is provided that positions a target for receipt of dispersed material. Additionally, a moving mechanism positions the first tube so that material is ejected from the first and second tubes on to the target positioned by the target rotator. The target rotator may also be positioned by the moving mechanism.

### CROSS-REFERENCE TO RELATED APPLICATION

The present application claims the benefit of U.S. provisional patent application, serial No. 60/375,863, filed Apr. 26, 2002, which is hereby incorporated by reference in its entirety.

### FIELD OF THE INVENTION

The invention relates generally to a dispersion device, and more specifically, to an apparatus, system, and method for oscillating dispersion of a material.

### BACKGROUND OF THE INVENTION

Filtration is the process involving passing a liquid or gas through a porous substance in order to remove constituents, such as suspended matter. One aspect of filtration is to remove foreign particles that would otherwise pollute the liquid or gas being filtered to unacceptable levels. Designers and builders implement many alternatives to accomplish particle removal through filtration.

The typical swimming pool or hot tub circulation pump is a centrifugal pump that moves the water by impeller action. Water is drawn into the eye of the impeller, thrown from the outer perimeter of the turning impeller into the chamber enclosing the impeller, and then forced into the piping system. If the water is filtered at the suction side of the pump, it is discharged from the pump directly back to the pool. The filter system may be a vacuum or gravity system. If the water is filtered prior to the pump, it is discharged from the pump to a filter station and then on to the pool. This configuration is a pressure system, since the water is delivered to the filters under pressure.

As the particle removal process takes place in a filter, the particle accumulation in the filter increases resistance to flow. This accumulation eventually reduces the flow to a point where the filter should be cleaned or replaced. A cartridge used in a pool or spa filter may employ a stationary filter material that is periodically removed and cleaned in a hosing process.

Cartridge filters are typically cleaned according to a process that involves removing the cartridge from the filter housing and rinsing it with a water hose to remove loose debris. Commercial cartridge cleaning solutions may also be utilized to aid in dislodging and dissolving the accumulated particles. To remove calcium or mineral buildup, the cartridge may be soaked in a separate solution and then thoroughly rinsed before returning the cartridge to the filter housing. A cartridge filter may require substantial time to be manually cleaned with a water hose, which may be due to the large number of the longitudinal pleat folds that are common in these types of filters. Cleaning involves combing each pleated section with water. It is also common in this process for the water and effluent debris to splash onto the operator and the surrounding area. Also, because this process is manual and involves manually rotating the filter, inconsistent cleaning often results.

Other potential solutions include cleaning the filter using centrifugal action and a handheld garden hose; however, this process relies on manual operation and usually causes water to splatter and splash onto the operator and the surrounding area. Because of the high rate of spin in the centrifugal implementation, water typically is not injected between and does not comb the pleats. Thus, debris remains, resulting in unsatisfactory cleaning.

Cleaning through high-pressure washing may be accomplished using a hand-held or controlled nozzle that is directed by a human operator to the high particle accumulation areas of the target filter. However, many of the same deficiencies plague this solution as well.

A plurality of nozzles may also be employed with the robotic arm to achieve coverage. A variety of liquids, some toxic to humans, may be dispersed through the air, thereby causing splatter against the object and in the process dislodging dirt and contaminants. Thus, there is ample opportunity for injury through accident or even toxic exposure.

In similar fashion, painting and coating systems are generally accomplished using a hand-held or robotically controlled plurality of nozzles to wash the object in a mist of air-borne, water-borne, or solvent-borne paints. Because some solvents are hazardous and because the dispensing nozzles are hand-held, there is ample opportunity for overcoating, as the nozzle is directed at one spot or area for too long of a time, or undercoating as the nozzle is not directed long enough at one spot or area for a sufficient time. Moreover, computer-controlled robotic paint control usually involves many moving parts, high cost, and programming complexity.

Other cleaning devices involve pumping material containing solvents out of a sump against the surface of the object. Still other devices rely on biological organisms, specific pressures, or cleaning reagents to break down the effluent. Some rely on suction, vacuum, heating, purging, solvents, brushes, supercritical temperatures, lamps, and wheels.

Applying coatings sometimes may involve washing in a bath, dunking, or dredging the object and the conveyor through an open vat of liquid, which is sometimes caustic acid or hot oil. The excess is then allowed to drip off, hopefully into collection pans where it is either disposed of or recycled.

Some devices use or rely on hand-held devices to direct the spray, a high rate of spin, centrifugal force, nozzles, valves, backwashing, biological organisms, chemical reactions of reagents, pumps, sumps, basins containing solvents or reagents, mixing soaps, drying cycles, or specific measurements or dimensions or pressures.

### SUMMARY OF THE INVENTION

Embodiments of the invention can also be viewed as providing an apparatus, system, and method for oscillating dispersion of a material. In this regard, one embodiment, among others, can be broadly summarized as including a first tube having a plurality of openings through which material passes. This first tube includes two or more openings, such that one opening is positioned at an end of the first tube that is coupled to a source. In addition, another of the openings is positioned along the length of the first tube. A second tube or guide is provided with an opening positioned at its end for receipt of a portion of the first tube. The second tube also has one or more openings positioned along its length. A target rotator is provided that positions a target for receipt of dispersed material. Material may include, without limitation, water, oil, solvents, solutions, paints and other liquids; sand, grit, pellets, and other particles; microwaves, light waves, and other wavelengths of energy; air, oxygen and other gases; electrons, photons and other subatomic particles; and any combination. Additionally, a moving mechanism positions the first tube so that material is ejected from the tube on to the target positioned by the target rotator. The target rotator may also be positioned by the moving mechanism.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1A-1D are diagrams of an assembly that translates a rotational action from a crank or shaft to a lateral oscillating motion.

FIG. 2A is a diagram of the dispersion tubes that are controlled by the motor assembly of FIG. 1A.

FIG. 2B is a diagram of the assembly that comprises the motor assembly of FIG. 1A coupled to the tubes of FIG. 2A.

FIGS. 3A and 3B are diagrams of the rotation assembly that include the assembly of FIG. 1A with two matched transfer gears and that turn roller drive shaft connected to gear.

FIG. 4 is a diagram of the motor assembly of FIG. 1A coupled to the rotation assembly of FIG. 3A and the oscillating assembly of FIG. 2A.

FIG. 5 is a diagram of an enclosure that house dispersing device of FIG. 4.

FIG. 6 is a diagram of an alternative embodiment to the dispersing device of FIG. 4.

FIG. 7 is a diagram of the alternative embodiment dispersion device of FIG. 6 shown housed in an enclosure.

FIG. 8 is a diagram of an alternate embodiment of the oscillator assembly, as shown in FIG. 2A.

### DETAILED DESCRIPTION OF THE PREFERRED EMBODIMENT

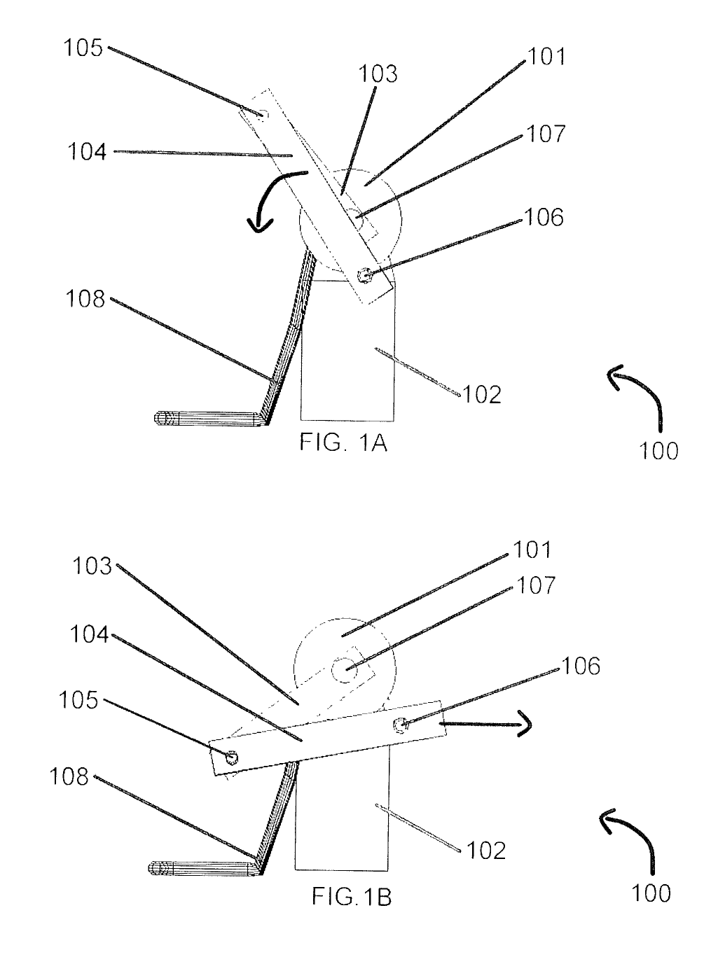

FIGS. 1A-1D are diagrams of an assembly 100 that translates a rotational action from a crank or shaft to a lateral oscillating motion. One of ordinary skill in the art would know that many variations of this kind of assembly 100 are possible.

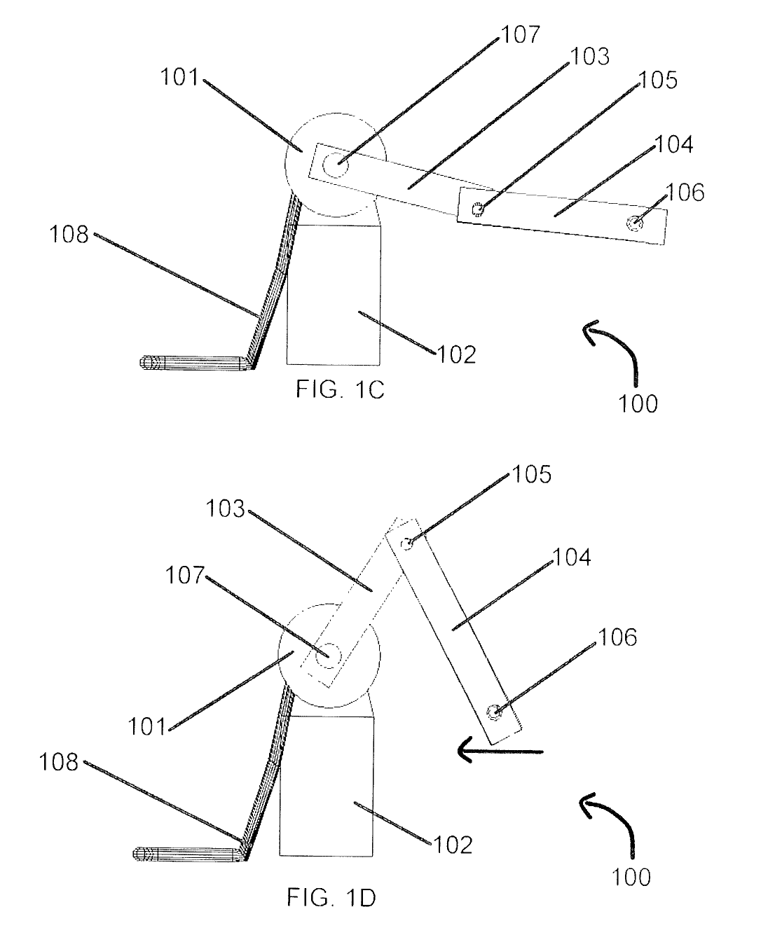

FIG. 1A shows motor 101 mounted on base 102 with electricity supplied through wire 108. One of ordinary skill in the art would know, however, that motor 101 may be powered by other means including, but not limited to water, air, or some other fluid. Shaft 107 of motor 101 is connected to cam 103, which in turn is connected to rocker arm 104 by connector 105. Rocker arm 104 is connected to effecter 106. Effecter 106 transfers the force of the motion to an inner oscillator tube (reference numeral 207 in FIG. 2A). FIG. 1A shows device 100 in its fully contracted position.

FIG. 1B shows device 100 after approximately a 90-degree counter-clockwise (as viewed from the perspective of the observer) turn of motor shaft 107. Motor shaft 107 rotates cam 103, which moves rocker arm 104 and pin 106. One of ordinary skill would know that motor 101 may also be controlled to operate in a clockwise orientation. FIG. 1C shows device 100 in an extended position. In this figure, motor 101 has rotated shaft 107 approximately 180-degrees from the original position in FIG. 1A. As cam 103 continues to rotate in a counter-clockwise orientation, it moves rocker arm 104 (and, in turn, effecter 106).

FIG. 1D shows device 100 in the final stage of the cycle. In this position, motor shaft 107 has rotated about 270-degrees from the position shown in FIG. 1A and cam 103 is approximately positioned in a vertical orientation. Also in FIG. 1D, effecter 106 is shown in a retracted position from FIG. 1C.

FIG. 2A is an exploded view of two tubes, 207 and 208, controlled by device 100 in FIG. 1A. Tube 207 has one or more openings 202, which in operation is inserted into tube 208, which also has one or more openings 201. FIG. 2B is a diagram of the assembly of FIG. 2A coupled to motor 101 of FIG 1A. The assembly shown in FIG. 2B is comprised of motor assembly 100 coupled to tube 207 that has a plurality of openings; one to admit material and at least one other (in this non-limiting example, two openings 202) to eject material. The material-admitting opening of tube 207 is coupled to inlet hose 209, which in this non-limiting example, introduces to a material source under pressure.

It should be noted that the ejected or emitted material may include, without limitation, water, oil, solvents, solutions, paints and other liquids; sand, grit, pellets, and other particles; microwaves, light waves, and other wavelengths of energy; air, oxygen and other gases; electrons, photons and other subatomic particles; and any combination.

Tube 207 is positioned within outer tube 208. Outer tube 208 has a longitudinal opening 201 and an opening (not referenced) to admit inner tube 207. Outer tube 208 thus acts as a sleeve and guide for inner oscillating tube 207. Material 203 ejects from opening 202 and passes through opening 201 of outer tube 208. The opening 201 may serve to further form or direct the ejection stream 203.

As effecter 106 moves tube 207 laterally within outer guide 208, a material ejection stream oscillates laterally as well. The pressure of the output stream is proportional to the pressure of the input material, diameter of tubes and hoses involved, the viscosity of the material, and the size of the intersection of the openings in tubes 207 and 208.

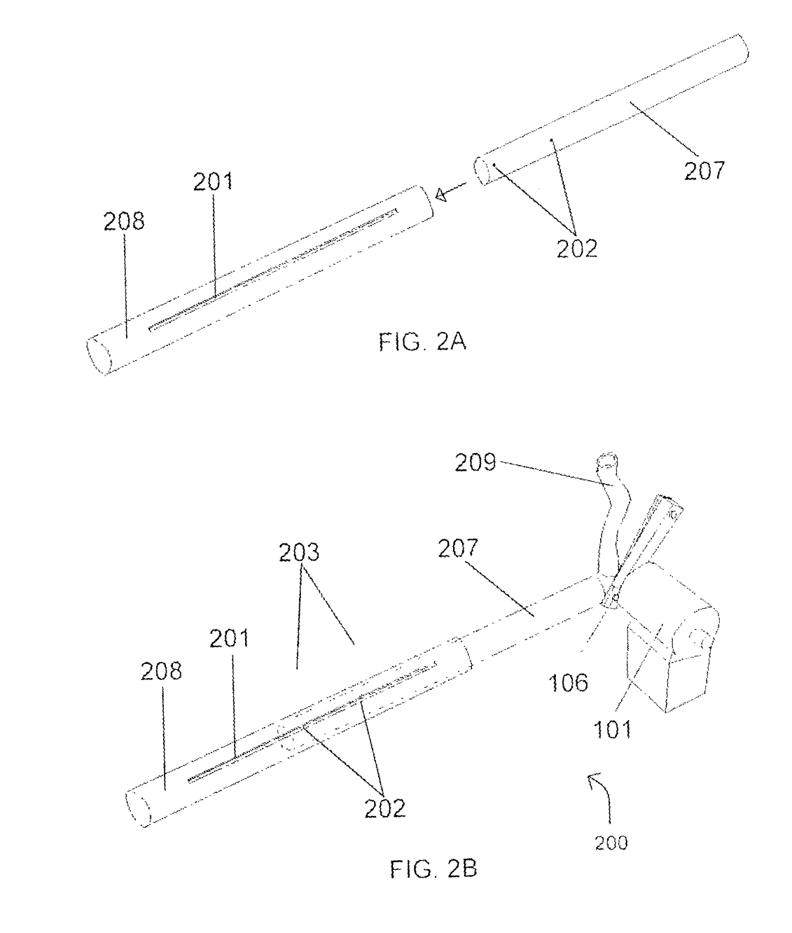

FIGS. 3A and 3B are diagrams of rotation assembly 300 comprised of the assembly 100 of FIG. 1A with two 45-degree matched transfer gears 311 and 312 (FIG. 3B). Motor 101 rotates gear 311, which, in turn, rotates gear 312. Gear 312 is positioned at a right angle to gear 311; however, one of ordinary skill would know that other orientations would work as well. As gear 312 rotates, it communicates radial motion to roller drive shaft 313, which is coupled to gear 314. As gear 314 rotates, roller drive gear 315 also rotates, which is coupled to roller 316.

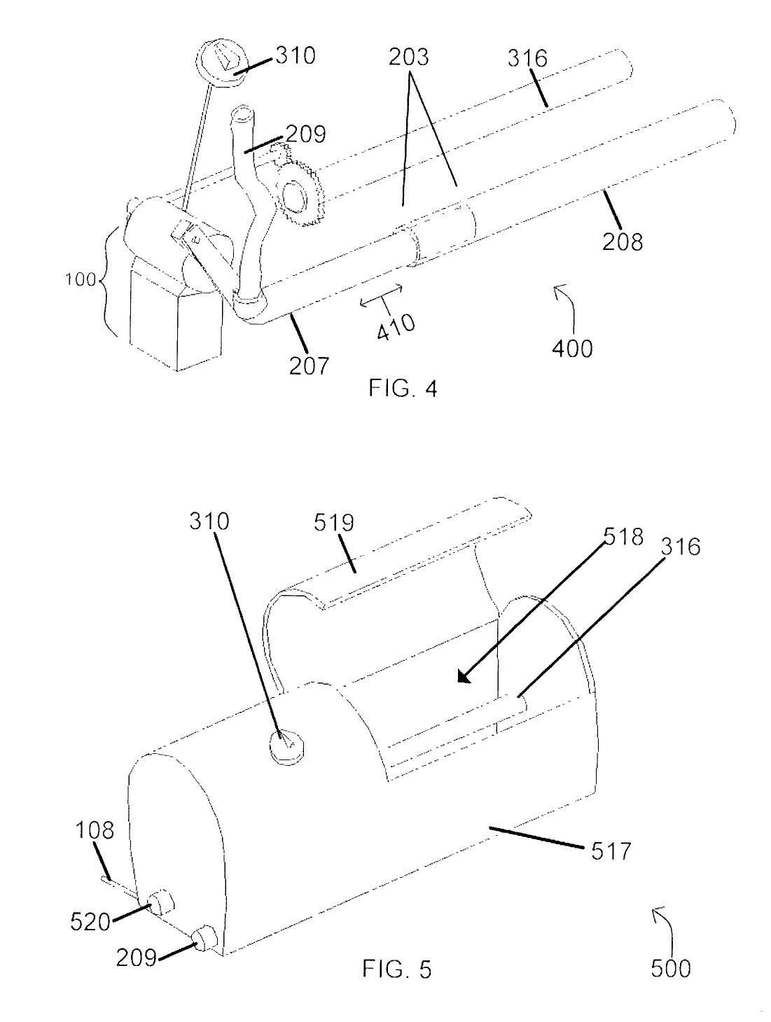

Timer 310 controls the on/off current flow of electricity (or other power supply such as air, water, etc.) to the motor 101. Motor assembly 100, timer 310, shaft 313, and roller 316 are held in place by a case (shown as reference numeral 517 in FIG. 5). Roller 316 may, in an alternative embodiment (not shown), be directly connected to shaft 313, or connected by gears, pressure rollers, belts and/or clutches (also not shown).

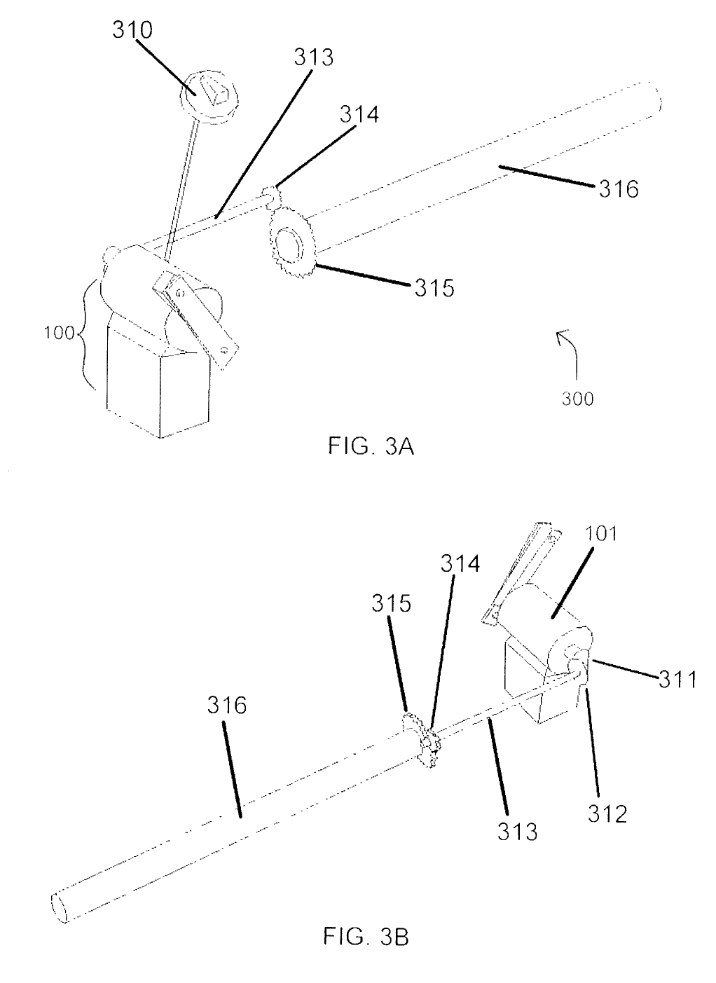

FIG. 4 is a diagram of the assembly that comprises the motor assembly of FIG. 1A coupled to material dispersion tubes of FIG. 2A. Motor assembly 100 operates to rotate roller 316 while simultaneously moving tube 207 inside tube 208 in lateral fashion 410 to disperse the material 203 onto a target positioned on roller 316. Thus, an emitted stream travels across the length of roller 316 while a target positioned on roller 316 rotates. Thus, with the rotation of roller 316 and the lateral movement of tube 207 within tube 208, effective dispersion coverage on the target is obtained.

FIG. 5 is a diagram of an enclosure that houses dispersing device 400 of FIG. 4. In FIG. 5, dispersing device 400 is enclosed in case 517. Case 517 may be configured in any shape to house dispersing device 400, so case 517, as shown in FIG. 5 is merely a non-limiting example. Case 517 includes object compartment 518 with lid 519. Outlet 520 allows spent material to exit case 517. Also shown are timer 310, inlet hose 209, roller 316, and electrical cord 108 (or other power supply) for motor 101 of FIG. 1A. Inlet tube 209 (FIG. 2B) connects to the material source (i.e. water, air, paint, solvent, etc.).

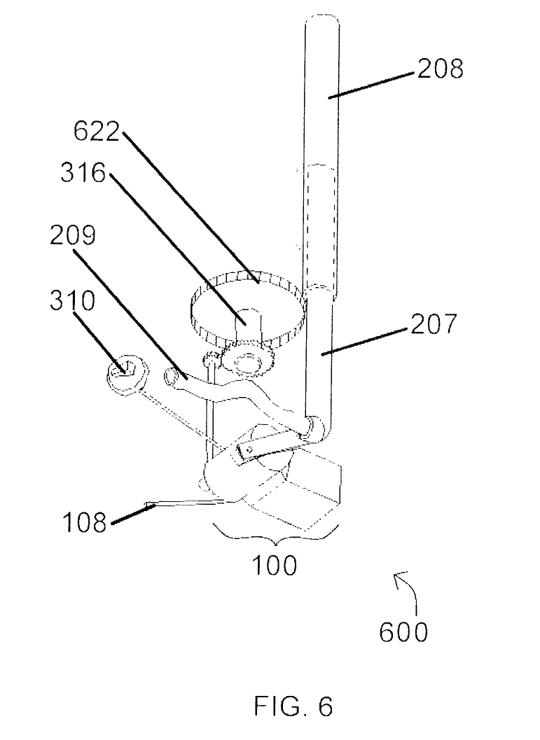

FIG. 6 is a diagram of device 600, which is an alternative embodiment to the dispersing device 400 of FIG. 4. More specifically, diagram 600 shows turntable 622 coupled on roller tube 316. Roller tube 316 turns turntable 622 while the oscillator assembly 200 sprays material, as tube 207 oscillates laterally within tube 208. One of ordinary skill would know that a variety of configurations exist to rotate the target in addition to roller 316 and turntable 622.

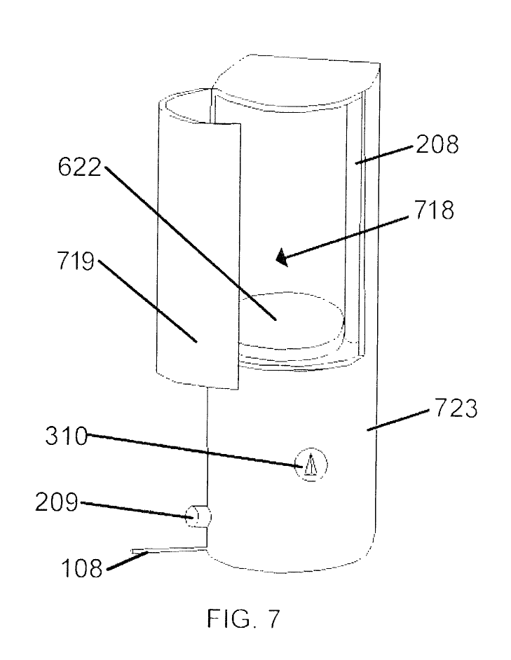

FIG. 7 shows the device 600 of FIG. 6 mounted inside an enclosure 723. Turntable 622 and oscillator tube 208 are supported by case 723. Also shown are timer 310, power cord 108, and material inlet 209. In this embodiment, an object is positioned within compartment 718 on turntable 622. When lid 719 is closed, the device operates, as described above and shields the operator from any overspray.

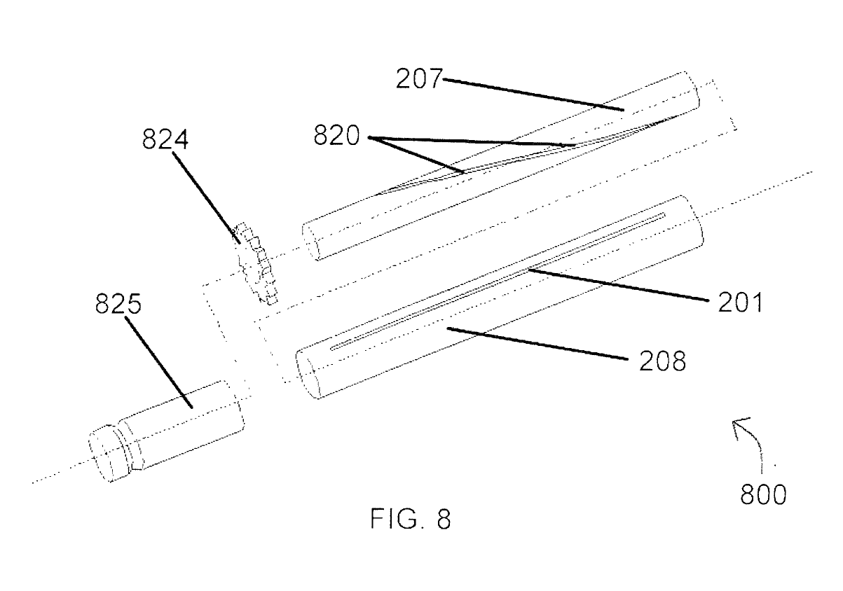

FIG. 8 shows an alternate embodiment of the material oscillator assembly 800 in an exploded view with an assembly line, which is similar in function to that shown in FIG. 2A. In this embodiment, inner oscillator tube 207 has one or more helical pattern openings 820 along its length instead of the two openings shown in an earlier embodiment. Tube 207 is positioned inside tube 208 that has longitudinal opening 201. Tube 207 is rotated by gear 824. As tube 207 rotates, the intersection of the two tubes' openings moves down the length of outer oscillator tube's opening 201. Thus, material disperses is an oscillating fashion.

Coupler 825 serves to couple tube 207 to a material source but allows tube 207 to rotate. Coupler 825 and sleeve tube 208 remain stationary in this one embodiment. However, one of ordinary skill would know that tube 207 could be configured to remain stationary while tube 208 rotates to disperse material.

In this embodiment, as material flows into the inlet tube 207 it is afforded a means of escape through the center opening in rotating gear 824, into tube 207, and out an opening made by the intersection of a helix cut 820 in tube 207 and a longitudinal cut 201 in a tube 208. Since the opening traverses the length of the tube opening 201 for each revolution of tube 207 with the helical cut, the ejected material oscillates in a pattern. Different patterns of helical openings will yield different spray patterns; therefore, one of ordinary skill would know that different patterns may be created.

Oscillating action may be accomplished by motor 101 spin or operator cranking, through a power transfer mechanism, to the inner tube 207 of the dispensing device 400. While a motor is shown in the preferred embodiment, one of ordinary skill would know that other devices may be used including without limitation a hand crank, spring, or impeller mechanism, depending on the material used, viscosity, and object weight.

Gravity may be sufficient to keep the object on the roller 316, but any sort of friction/compression device may also be added to press a less-dense object against the roller 316 to assist with smooth rotation and consistent placement of the object. Depending on the effectiveness of the cleaning material, speed of the oscillator, rotational speed of the roller, and the size and dirtiness of the object, the object may be cleaned after one rotation of the object. The object may be rotated several times for the desired level of cleaning. The cleaned object, such as a hot tub cartridge filter, or coated object, such as a museum piece, once sprayed with dispersing device 400, may be removed from the device 500 (FIG. 5) and placed back into operation or packed and shipped as the case may be.

In the case of coating the object is device 517 (FIG. 5) or 723 (FIG. 7); the compartment 518 (FIG. 5) or 718 (FIG. 7) can accommodate a variety of object sizes, shapes, and weights. The object can be placed into the compartment on the rollers 316 (FIG. 5) or turntable 622 (FIG. 7). A timer 310 can be set, which controls the motor 101. The motor 101 rotates the object as the dispersing device 400 (FIG. 4) or 600 (FIG. 6) sprays coating material (such as oil) along the length of the object's surface. Depending on the density and stickiness of the coating material, the object is covered after one or more of rotations of the object by the rollers 316. The excess material is discharged through the drain 520 (FIG. 5) for re-use or disposal. The coated object may then be removed from the device 517 and shipped, stored, or further used.

Use of a stepper motor (not shown) may enable the position of the dispersed stream to be controlled by a software program or other stepper motor control device. In this alternative embodiment, control may be exercised over the periodicity of the material oscillations and the position of the ejected stream.

One of ordinary skill would know that the tube 208 may be a set of guides, rings or positioning apparatus to guide the movement of the tube 207. In this alternative embodiment, the guide, rings or positioning apparatus 208 may be incorporated into the moving mechanism that positions the tube 207. In addition, the openings 202 in the tube 207 for material dispersion may include a number of holes.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. An apparatus for dispersing a material received from a source comprising:
a first tube having a plurality of openings through which material passes, wherein one of the plurality of openings on the first tube is positioned at an end of the first tube that is coupled to the source and one or more of the plurality of openings is positioned along the length of the first tube;
a second tube having an opening positioned at an end of the second tube for receipt of a portion of the first tube within the second tube and one or more openings positioned along the length of the second tube; and
a moving mechanism to position the first tube so that material is ejected from the first and second tubes.

2. The apparatus of claim 1, further comprising:
a target rotator that positions a target for receipt of dispersed material.

3. The apparatus of claim 2, wherein the moving mechanism is controlled by a timer.

4. The apparatus of claim 2, wherein the moving mechanism is a motor.

5. The apparatus of claim 2, wherein the target rotator is a tube upon which the target is positioned.

6. The apparatus of claim 2, wherein the target rotator is a turntable upon which the target is positioned.

7. The apparatus of claim 2, further comprising:
an enclosure to house the first and second tubes, the rotator, and the moving mechanism.

8. The apparatus of claim 7, further comprising:
an inlet for receiving the material from the source; and
an outlet for exhausting material dispersed from the second tube.

9. The apparatus of claim 1, wherein the second tube is a plurality of guides to direct the movement of the first tube.

10. The apparatus of claim 1, wherein one of the openings in the first tube is positioned along the length of the first tube as an exit opening for the material to transfer from the first tube.

11. The apparatus of claim 1, wherein one of the openings in the first tube extends longitudinally along a portion of the length of the first tube.

12. The apparatus of claim 1, wherein one of the openings in the second tube extends longitudinally along a portion of the length of the second tube.

13. The apparatus of claim 1, wherein one of the openings in the first tube forms a helix.

14. A system for dispersing a material received from a source comprising:
means for adjusting a stream of material in a lateral movement plane, wherein the stream of material cycles throughout the movement plane; and
means for rotating a target, wherein the target receives the material dispersed within the movement plane;
means for terminating the dispersion of material on the target.

15. The system of claim 14, further comprising:
means for containing the dispersion of material within a confined space.

16. A method for dispersing a material, comprising the steps of:
passing a material into an inner tube, the inner tube has a plurality of openings, wherein one of the plurality of openings is positioned at an end of the inner tube a second of the plurality of the openings is positioned on the length of the inner tube;
transferring the material from the inner tube through an opening in an outer tube, wherein the outer tube contains at least the portion of the inner tube with the opening positioned on the length of the inner tube and the opening in the length of the outer tube creates an opening positioned on the length of the inner tube; and
moving one or both of the inner and outer tubes, wherein the intersection of the opening in the outer tube and the opening positioned on the length of the inner tube oscillates within a movement area.

17. The method of claim 16, further comprising the step of:
rotating a target so that material that is dispersed in the movement plane contacts the target.

18. The method of claim 17, further comprising the step of:
controlling the dispersion of material for a proscribed time period.

19. The method of claim 17, further comprising the step of:
controlling the pressure and dispersion coverage area.

20. The method of claim 17, wherein the target is rotated by a motor.

21. The method of claim 16, wherein the opening positioned on the length of the outer tube extends longitudinally along a portion of the length of the outer tube.

22. The method of claim 16, wherein the opening positioned on the length of the inner tube extends longitudinally along a portion of the length of the inner tube.

23. The method of claim 22, wherein the longitudinal opening in the inner tube forms a helix.

24. The method of claim 16, wherein the movement of the inner and outer tubes is laterally with respect to each other.

25. The method of claim 16, wherein the movement of the inner and outer tubes is axially with respect to each other.
